(19) United States
(12) Patent Application Publication
(10) Pub. No.: US 2008/0046319 A1
(43) Pub. Date: Feb. 21, 2008

(54) Method and System For Determining Fuel Pricing

(76) Inventors: James Barry, Madison, CT (US); James Cole, East Setauket, NY (US); Jeffrey Devaney, Sandy Hook, CT (US); Thomas O'Halloran, Gaylordsville, CT (US); Matt Marcella, West Hempstead, NY (US)

Correspondence Address: FAY KAPLUN & MARCIN, LLP, 15O BROADWAY, SUITE 702, NEW YORK, NY, 10038, US

(21) Appl. No.: 11/780,811

(22) Filed: Jul. 20, 2007

Related U.S. Application Data
(60) Provisional application No. 60/832,564, filed on Jul. 20, 2006.
(60) Provisional application No. 60/885,478, filed on Jan. 18, 2007.

(51) Int. Cl. G06F 17/00; G06F 17/30; G06Q 30/00

(52) U.S. Cl. 705/14; 705/1; 705/413

(57) ABSTRACT

A system and method for receiving an aircraft identifier corresponding to an aircraft, retrieving information on the basis of the aircraft identifier, determining an attractiveness of an operator of the aircraft as a potential customer based on at least the retrieved information and determining a suggested fuel price based on at least the attractiveness of the operator as a potential customer.

### PRIORITY CLAIM

This application claims priority to the U.S. Provisional Application Ser. No. 60/832,564, entitled “Fuel Pricing Algorithm and Decision Support,” filed Jul. 20, 2006, and to the U.S. Provisional Application Ser. No. 60/885,478, entitled “Fuel Based Information Portal for Fixed Based Operator,” filed Jan. 18, 2007. The Specifications of the above-identified applications are incorporated herewith by reference.

### BACKGROUND

Fixed based operators (“FBO”) of aviation fuel sale operations sell fuel to a wide variety of customers ranging from recreational pilots of small aircraft to airlines with fleets comprising hundreds of large aircraft. It is desirable to cultivate beneficial relationships with customers who will purchase large amounts of fuel, both at present and in the future. To do this, FBOs may wish to dynamically generate different fuel prices for different customers in order to establish such beneficial relationships with potential large-volume purchasers.

### SUMMARY OF THE INVENTION

A method for receiving an aircraft identifier corresponding to an aircraft, retrieving information on the basis of the aircraft identifier, determining an attractiveness of an operator of the aircraft as a potential customer based on at least the retrieved information and determining a suggested fuel price based on at least the attractiveness of the operator as a potential customer.

A system having an interface operable to receive a unique aircraft identifier corresponding to an aircraft and display results to a user and a processor operable to retrieve information corresponding to the unique aircraft identifier from one or more data sources and determine an attractiveness of an operator of the aircraft based on at least the data retrieved from the one or more databases.

### DESCRIPTION OF THE DRAWINGS

FIG. 1 shows an exemplary system according to the present invention.

FIG. 2 shows an exemplary method for dynamically generating fuel pricing according to the present invention.

### DETAILED DESCRIPTION

The present invention may be further understood with reference to the following description and the appended drawings, wherein like elements are referred to with the same reference numerals. The exemplary embodiments of the present invention describe a method and system for dynamically generating aircraft fuel prices. The exemplary embodiments generate prices in a manner that considers a variety of factors so as to maximize fuel sales both currently and on future occasions. The exemplary system and method will be discussed in detail below.

The optimal price at which to sell fuel depends on a large variety of factors. A number of these factors depend specifically on the type of aircraft being evaluated. For example, the amount of fuel that the operator of an aircraft will purchase may depend on the size of an aircraft (and thus its fuel capacity), as well as its cruise speed and its fuel burn rate (which determine the amount of fuel needed for a trip of a given distance).

Additionally, an aircraft's flight plan may have an impact on fuel pricing. The operator of an aircraft with a distant future destination will typically need to purchase more fuel than the operator of an aircraft with a closer future destination. Further, if the price of fuel at the aircraft's future destination is high, the operator may wish to purchase additional fuel at the current airport (referred to as “tankering”). It should be noted that, throughout this disclosure, the terms “owner,” “operator,” and “owner/operator” will be used interchangeable to refer to an entity (e.g., an individual or a business entity) who owns and/or operates an aircraft.

Those of skill in the art will understand the close relationship between fuel prices, quantity of fuel purchased by the operator of an aircraft, and the profitability of the fuel provider's operation. The provider's goal is to set an optimal price that will balance the desires to maximize the quantity of fuel purchased by an aircraft's operator on present and future occasions and to maximize the price paid per gallon of fuel; the exemplary embodiments of the present invention help to achieve that balance.

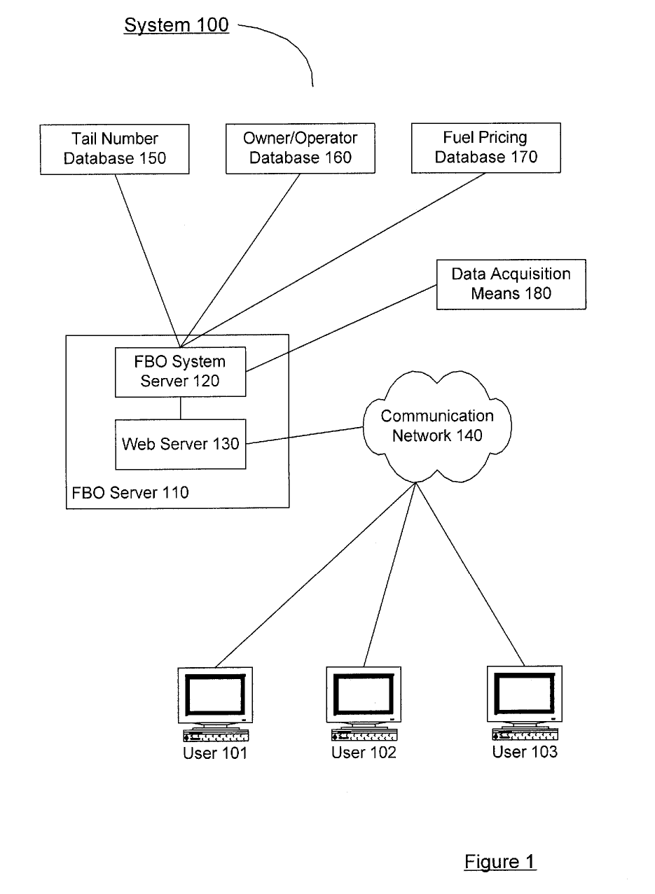

FIG. 1 shows an exemplary system 100 for implementing the exemplary embodiments of the present invention. The FBO server 110 may be accessed by a plurality of users 101, 102, 103 via a network 140; the users 101, 102, 103 may, in some exemplary embodiments, also operate and maintain the FBO server 110. The user interface to accomplish this interaction may be, for example, a program accessed via the Internet such as using a web browser, or may be a program installed on the local user computers 101, 102, 103. The FBO server 110 may include an FBO system server 120 for performing calculations and retrieving data and a web server 130 for serving content to the users 101, 102, 103. Those of skill in the art will understand that the precise number of users who can access the FBO server 110 may vary; the presence of three users 101, 102, 103 is merely intended to be exemplary. The discussion of the exemplary embodiments herein refers specifically to user 101; however, the processes described are equally applicable to any user of the FBO server 110. Additionally, reference to the user 101 is intended to encompass both the individual who is accessing the system 100 and the computer terminal through which the individual obtains that access.

The FBO server 110 also communicates, via the FBO system server 120, with a group of databases or data sources. These may include, in the exemplary embodiment, a tail number database 150, an owner/operator database 160, and a fuel pricing database 170. In other embodiments, other databases or data sources may also be included to add further input data to the method 200.

The tail number database 150 allows a user 101 of the FBO server 110 to input the tail number of an aircraft and obtain various types of information about the aircraft. This information may include the type of aircraft (manufacturer, model number, engine type, etc.), its performance characteristics (e.g., its cruising speed, fuel burn rate, or fuel tank size), and the identity of its operator. Such information is useful for determining the fueling needs of the aircraft.

The owner/operator database 160 contains various data about the owners and operators of a large number of possible aircraft that may need to purchase fuel from the user 101 that is accessing the FBO server 110. This information may include the number of aircraft owned by the owner/operator, the other types of aircraft owned by an owner/operator of multiple aircraft, the frequency with which the owner/operator visits the particular airport, the locations of other airports that the aircraft previously visited or is about to visit, etc. Such information is useful in predicting the ability of the owner/operator to potentially purchase large amounts of fuel in the future.

The fuel pricing database 170 contains various data relating to fuel pricing. This data may include the price paid for the fuel to be sold by the user 101, the price of fuel at the aircraft owner/operator's previous departure point and future destination, the average price of fuel in the country at present, etc.

In other implementations of the system 100, the FBO system 110 may communicate with a data acquisition means 180 (e.g., passive radar or government radar). In such embodiments, the data acquisition means 180 may be able to obtain, for example, a tail number for an aircraft that may require refueling, e.g. an aircraft that is currently in a landing pattern for the airport. Other types of data that may be obtained by the data acquisition means 180 include the position of the aircraft, the beacon or transponder code of the aircraft, the altitude of the aircraft, etc. In such implementations, the FBO system 110 may automatically obtain the tail number from all aircraft within range of the data acquisition means 180, making it unnecessary for the user 101 to manually input tail numbers.

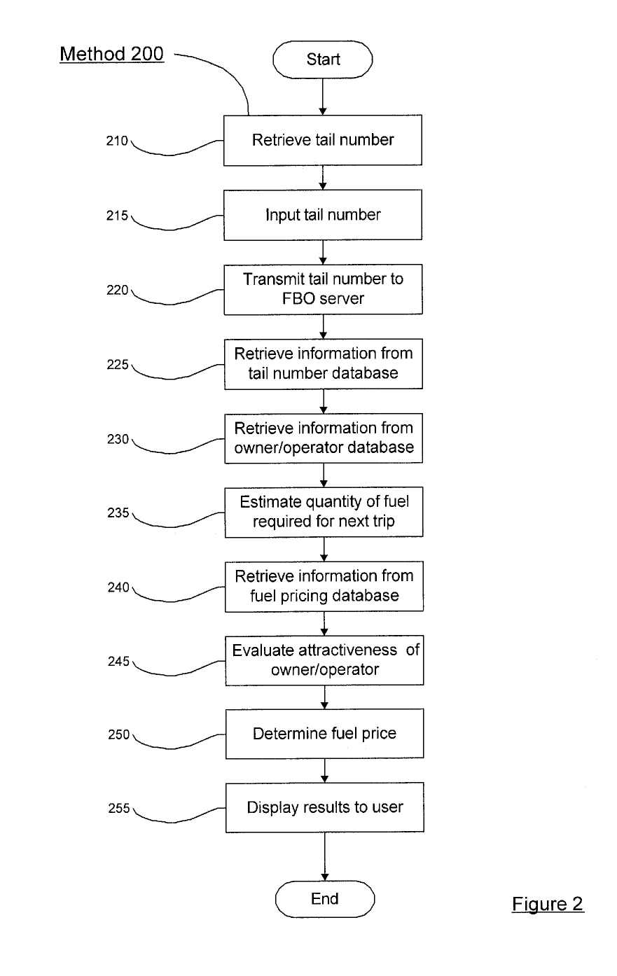

FIG. 2 shows an exemplary method 200 by which the exemplary system 100 may operate. In step 210, the tail number for an aircraft is obtained. This may be accomplished using data acquisition means such as passive radar, or alternately by visual inspection of a landed aircraft or communication with the pilot of an aircraft. In step 215, the tail number is input by the user 101. In step 220, the tail number is transmitted to the FBO server 110 via the network 140 (assuming it has not been automatically entered into the FBO server 110 by the data acquisition means 180).

In step 225, the FBO system server retrieves information about the aircraft from the tail number database. This information may include the aircraft make, model number, engine characteristics, performance characteristics, owner/operator's name, etc. In step 230, the FBO system server retrieves information about the operator of the aircraft from the owner/operator database. This information may include the size of the operator's fleet, the number of previous visits to the airport by this aircraft or other aircraft in the operator's fleet, the aircraft's future flight plan, etc. As described above, the data used to determine the fuel requirements, fuel price, etc., may be retrieved from a variety of data sources. The data sources described herein are only exemplary.

From the information retrieved in steps 225 and 230, an estimate of the aircraft's fuel requirements is calculated in step 235. This calculation is typically based on the aircraft's fuel burn rate (typically expressed in gallons per hour), cruise speed (typically in knots), and the distance to the aircraft's next destination (in nautical miles). Alternatively, the user 101 may be able to manually enter one or more of these input values (e.g., if there has been an error in data retrieval, etc.) The calculation may proceed as follows.

The distance of the aircraft's route is typically initially multiplied by a ten percent safety factor to account for the fact that aircraft do not fly point to point. This modified distance is then divided by the cruise speed to estimate time spent in the air. The time estimate is multiplied by a further ten percent factor to account for acceleration and deceleration. This modified time estimate is then multiplied by the fuel burn rate to arrive at the required fuel for a given flight.

For example, consider an aircraft with a cruise speed of 460 kts and a fuel burn rate of 508 gallons per hour traveling 632 NM to its next destination. Increasing the distance by the safety factor results in a modified travel distance of 632 NM*1.10=695 NM. On this basis, travel time is estimated to be 695 NM/460 kts=1.51 hrs. Adding the second safety factor results in a modified flight time estimate of 1.66 hours. Multiplying this time estimate by the fuel burn rate yields a fuel requirement of 1.66 hrs*508 gal/hr=844.5 gallons.

In step 240, the FBO system server retrieves information about fuel prices from the fuel prices database 170. This information may include the price the FBO operator paid for fuel and the fuel prices at the aircraft's previous and next destinations.

In step 245, the FBO system 110 evaluates the attractiveness of the owner/operator as a customer. This determination is made on the basis of the estimated fuel requirement calculated in step 235, the likelihood of the aircraft owner/operator to be a high-volume repeat customer based on data retrieved in step 230, the price of the fuel at the aircraft's next destination as retrieved in step 240 (a factor because the aircraft owner/operator might wish to tanker fuel purchased from the FBO if the future price will be significantly more expensive), etc. Such a determination will be based on a weighted average of the above factors; the particular weighting formula may vary among different implementations of the FBO system 100 and based on the wishes of the user 101.

Additionally, the weighted average may dynamically change based on changing inputs over time. For example, if the owner/operator purchases more aircraft, or if the distances being traveled are increasing, the likelihood of purchasing more fuel may increase; therefore, the attractiveness of attracting and retaining the owner/operator as a customer would increase accordingly. The attractiveness of the owner/operator as a customer may be expressed, for example, on a scale from one to five stars or a scale of one to ten points.

In step 250, the attractiveness of the owner/operator as a customer is used by the FBO system 110 to determine a recommended fuel price. The recommended price may be expressed as an actual fuel price (e.g., cost per gallon) or as a discount to the full price to be offered to an attractive customer (e.g., as a percentage). For example, a very good customer might receive a 30% discount off full price, a good customer might receive a smaller discount, and an average customer (e.g., one who presents little possibility of repeat business) might receive no discount at all.

In step 255, the results are transmitted to the user 101 from the FBO system 110 via the web server 120 and the network 140. At least the owner/operator attractiveness and the recommended fuel price will typically be displayed to the user 101; however, the user 101 may also be able to access any of the information retrieved about the aircraft in steps 225 and 230, and about fuel pricing in step 245. Using this output information, the user 101 can then sell fuel to the owner/operator of an aircraft at a price that will encourage attractive, high-volume customers to bring repeat business to the FBO. Additionally, as described above with reference to step 245, the user 101 may be alerted if information retrieved from the fuel prices database 170 indicates that fuel prices at the aircraft's next destination airport are expensive. Accordingly, the user 101 may advise the owner/operator of this fact and suggest that the owner/operator tanker additional fuel.

In another exemplary embodiment of the present invention, the FBO system 110 may also be capable of auditing the behavior of owner/operators. In such an exemplary embodiment, the FBO system server 120 may store historical information over a fixed period of time (e.g., the last twelve months) for a number of previous purchasers (e.g., all owner/operators who have purchased fuel over the fixed time interval). The historical information may include, for each previous visit by each owner/operator, the fuel requirement predicted by the FBO system 110 and the amount of fuel actually purchased by the owner/operator. The user 101 may then compare the two amounts; if the owner/operator has not purchased as much fuel as predicted, the owner/operator may then be considered a less attractive customer, and pricing may be adjusted accordingly.

It should be noted that while the above exemplary embodiments discuss the use of a tail number as a unique identifier for the aircraft 130, any other unique identifier may alternately be used. For example, another exemplary embodiment of the present invention might use the aircraft model number and serial number to accomplish the same tasks.

The exemplary embodiments of the present invention provide a system and method for dynamically generating fuel prices that are appropriate for each potential customer, and doing so with a minimal amount of necessary user input.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A method, comprising:
receiving an aircraft identifier corresponding to an aircraft;
retrieving information on the basis of the aircraft identifier;
determining an attractiveness of an operator of the aircraft as a potential customer based on at least the retrieved information; and
determining a suggested fuel price based on at least the attractiveness of the operator as a potential customer.

2. The method of claim 1, wherein the aircraft identifier is a tail number.

3. The method of claim 1, wherein the retrieved information is one or more of aircraft type, aircraft cruise speed, aircraft fuel burn rate, and aircraft fuel tank size.

4. The method of claim 1, wherein the retrieved information is one or more of an identity of the operator of the aircraft, a number of other aircraft owned by the operator of the aircraft, and a number of previous fuel purchases by the operator of the aircraft.

5. The method of claim 1, wherein the attractiveness is a value expressed using one of a ten-point scale and a five-star scale.

6. The method of claim 1, wherein the suggested fuel price is one of a price per gallon and a discounting percentage.

7. The method of claim 1, further comprising:
receiving a next destination for the aircraft.

8. The method of claim 7, wherein the data relating to the next destination is used in determining the attractiveness.

9. The method of claim 7, further comprising:
receiving a fuel price of the next destination.

10. The method of claim 1, further comprising:
calculating a needed amount of fuel for the aircraft.

11. A system, comprising:
an interface operable to receive a unique aircraft identifier corresponding to an aircraft and display results to a user; and
a processor operable to retrieve information corresponding to the unique aircraft identifier from one or more data sources and determine an attractiveness of an operator of the aircraft based on at least the data retrieved from the one or more databases.

12. The system of claim 11, wherein the processor is further operable to determine a suggested fuel price based on at least the attractiveness of the operator of the aircraft.

13. The system of claim 12, wherein the suggested fuel price is one of a price per gallon and a discounting percentage.

14. The system of claim 11, wherein the unique aircraft identifier is a tail number.

15. The system of claim 11, wherein the retrieved information is one or more of aircraft type, aircraft cruise speed, aircraft fuel burn rate, and aircraft fuel tank size.

16. The system of claim 11, wherein the retrieved information is one or more of an identity of the operator of the aircraft, a number of other aircraft owned by the operator of the aircraft, and a number of previous fuel purchases by the operator of the aircraft.

17. The system of claim 11, wherein the one or more data sources include one or more of a tail number database, an owner/operator database, and a fuel prices database.

18. The system of claim 11, wherein the processor is further operable to receive a next destination for the aircraft.

19. The system of claim 18, wherein data relating to the next destination is used in determining the attractiveness of the operator of the aircraft.

20. A computer readable storage medium including a set of instructions executable by a processor, the set of instructions operable to:
receive a unique aircraft identifier corresponding to an aircraft;
retrieve data from one or more databases on the basis of the unique aircraft identifier;
determine an attractiveness of an owner of the aircraft on the basis of at least the retrieved data; and
determine a fuel price on the basis of at least the attractiveness of the owner of the aircraft.
